(19) United States
(12) Patent Application Publication
(10) Pub. No.: US 2024/0190279 A1
(43) Pub. Date: Jun. 13, 2024

(54) ELECTRIC AUTOMOBILE WIND POWER GENERATION AND CHARGING DEVICE

(71) Applicant: Wenqing Sun, Changsha (CN)

(72) Inventor: Wenqing Sun, Changsha (CN)

(21) Appl. No.: 18/168,283

(22) Filed: Feb. 13, 2023

(30) Foreign Application Priority Data
Dec. 13, 2022 (CN) 202211601240.8

(51) Int. Cl. B60L 53/52; F03D 9/11; F03D 9/32; F03D 15/00; H02J 7/00; H02K 7/08; H02K 7/116; H02K 7/18

(52) U.S. Cl. CPC B60L 53/52; F03D 9/11; F03D 9/32; F03D 15/00; H02J 7/0045; H02K 7/083; H02K 7/116; H02K 7/183; F05B 2220/706; F05B 2240/941; H02J 2207/20

(57) ABSTRACT

An electric automobile wind power generation and charging device, wherein the generation device is provided in the front of the car and the top position of the car compartments, and the gearbox and impeller are provided inside the housing; the gearbox input shaft is connected to the impeller center shaft through a coupling, the gearbox output end is connected to the generator rotor shaft through the drive shaft, and the generator electrical output end is provided with a power converter. The wind rotates the impeller of the generator during driving, and the generator generates electricity to charge the battery, optimizing green wind energy with environmental protection and practicality, improving the automobile range; the generator is equipped with generated power matching the battery storage energy of the electric automobile, to guarantee the generated electricity meet the storage energy consumed by the automobile running, realizing the infinite automobile energy.

### 1. TECHNICAL FIELD

The invention relates to the field of vehicle engineering, in particular to an electric automobile wind power generation and charging device.

### 2. BACKGROUND ART

With the progress and development of society and increasing demands for automobiles, new-energy automobiles have become the mainstream development trend of today's society. Currently, most new-energy automobiles are electrically driven, and the batteries of new-energy automobiles are fully charged through charging to operate the automobiles through electric motors. New-energy automobiles are increasing the battery density to increase the power to achieve the purpose of range. However, due to the high charging frequency, long charging time and particular energy consumption, the development of new-energy automobiles have also been affected.

As a kind of transportation that can optimize wind energy, automobiles can fully use wind energy to save energy further and enhance environmental protection. Therefore, optimizing wind energy to convert into electricity to charge automobiles during the driving process becomes an effective way to use green energy from wind, for which the invention provides the electric automobile wind power generation and charging device.

### 3. SUMMARY OF THE INVENTION

The invention provides the electric automobile wind power generation and charging device to overcome the above technical defects.

The invention provides the electric automobile wind power generation and charging device to solve the above technical problem. The automobile wind power generation device is provided at the front of the car and the top position of the car compartment, and comprises a housing, an impeller, a gearbox and a generator; the gearbox and impeller are provided inside the housing, the gearbox input shaft is connected to the impeller central shaft through a coupling, the gearbox output end is connected to the generator rotor shaft through a drive shaft, and the generator electrical output end is provided with a power converter.

Preferably, the gearbox is provided insides with a large gear disk and a small gear disk connected to each other. The wheel shaft of the small gear disk is the input shaft of the gearbox and the wheel shaft of the large gear disk is the output shaft of the gearbox.

Preferably, the shaft body of the impeller center shaft is provided with a supporting bearing seat.

Preferably, the generator is equipped with a front bearing seat and a rear bearing seat at each end of the rotor.

Preferably, the bottom of the housing is fixed to the automobile body through the holder, and the housing is made of aluminum alloy plate or glass fiber, or carbon fiber composite material processing with a thickness of 2 mm.

Preferably, the coupling is provided with a semi-flexible connector structure.

Preferably, the housing is provided with a grille at the air inlet near the end of the impeller, and the grille is made of steel wire mesh.

Preferably, the power converter power output end is connected to the vehicle storage battery through the wire.

Compared to the prior arts, the invention has the following advantages:

The wind power speed increaser is mainly applied to wind turbines, with the benefits of small size, high load capacity, long service life, smooth operation, low noise, and reasonable temperature rise control.

When automobiles are running, the impeller of the generator is rotated by the wind, and the generator generates electricity to charge the battery, optimizing green energy from the wind with environmental protection and practicality, improving the automobile range; the generator is equipped with generated power matching the battery storage energy of the electric automobile, to guarantee the generated electricity meet the storage energy consumed by the automobile running, realizing the infinite automobile energy.

### 4. BRIEF DESCRIPTION OF ACCOMPANY DRAWINGS

FIG. 1 is a schematic diagram showing the structure of the automotive wind power generation device.

FIG. 2 is a schematic diagram showing the right-view structure of the impeller.

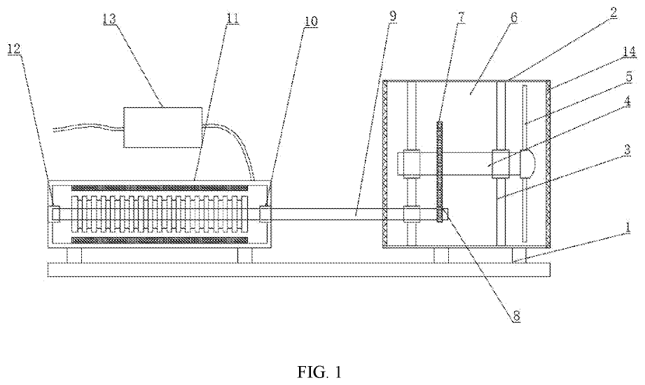

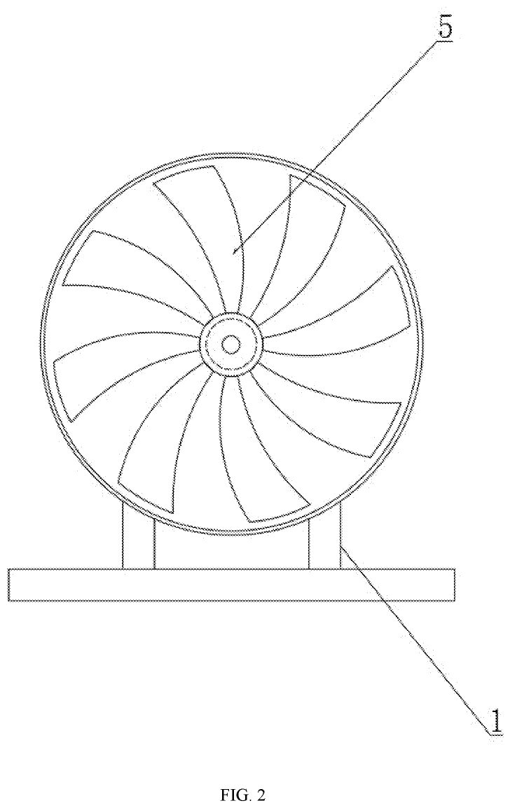

Referring to the FIG. 1 to FIG. 2, 1. the holder; 2. the housing; 3. the supporting bearing seat; 4. the central shaft; 5. the impeller; 6. the gearbox; 7. the large gear disk; 8. the small gear disk; 9. the drive shaft; 10. the front bearing seat; 11. the generator; 12. the rear bearing seat; 13. the power converter; 14. the grille.

### 5. SPECIFIC EMBODIMENT OF THE INVENTION

To make the technical solutions provided by the invention more comprehensible, exemplary embodiments according to the application are described below in detail with reference to the accompanying drawings. Apparently, the described embodiments are merely some embodiments of the application rather than all the embodiments of the application. It should be understood that the application is not limited to the exemplary embodiments described herein. The components of the embodiments of the invention generally described and illustrated in the accompanying drawings herein can be arranged and designed in a variety of different configurations.

In the specification of the disclosure, it is to be understood that terms such as ‘center’, ‘upper’, ‘lower’, ‘left’, ‘right’, ‘vertical’, ‘horizontal’, ‘inner’ and ‘outer’ refer to the orientations and location relations which are the orientations and location relations illustrated in the drawings, and for describing the disclosure and for describing in simple, and which are not intended to indicate or imply that the device or the elements are disposed to locate at the specific directions or are structured and performed in the specific directions, which could not be understood to the limitation of the disclosure. In addition, terms such as ‘first’, ‘second’, ‘third’ are used herein for purposes of distinctive description and are not intended to indicate or imply relative importance or significance or to imply the number of indicated technical features.

Further, terms like ‘horizontal’, ‘vertical’ and ‘suspended’ do not indicate that a component is absolutely horizontal or suspended, but it can be slightly inclined. For example, the term ‘horizontal’ merely means that the direction it indicates is horizontal relative to that indicated by the term ‘vertical’, but does not mean that a structure must be absolutely horizontal, instead, it may be slightly inclined.

In the description of the disclosure, ‘a plurality of’ and ‘multiple’ means two or more than two, unless specified otherwise.

In the descriptions of the disclosure, it should be noted that, unless otherwise specified or defined, the terms such as ‘mount’, ‘provide’, ‘arrange’ ‘connect’, and ‘assemble’ should be understood in a broad sense, for example, the connection may be a fixed connection, a detachable connection, or an integral connection; or the connection may be a mechanical connection, or may be an electrical connection or communication with each other; or the connection may be a direct connection, an indirect connection through an intermediary, or internal communication between two components or mutual interaction relationship between two components. The specific meanings of the above terms in the disclosure may be understood according to particular circumstances for a person of ordinary skill in the art.

The following is a further detailed description of an electric automobile wind power generation and charging device of the invention in conjunction with the accompanying drawings.

Referring to FIG. 1 to FIG. 2, an electric automobile wind power generation and charging device, wherein the automobile wind power generation device is provided at the front of the car and the top position of the car compartment, and comprises a housing 2, an impeller 5, a gearbox 6 and a generator 11; the gearbox 6 and impeller 5 are provided inside the housing 2, the gearbox 6 input shaft is connected to the impeller 5 central shaft 4 through a coupling, the gearbox 6 output end is connected to the generator 11 rotor shaft through a drive shaft 9, and the generator 11 electrical output end is provided with a power converter 13.

As a preferred embodiment of the invention, the gearbox 6 is provided insides with a large gear disk 7 and a small gear disk 8 connected to each other, the wheel shaft of the small gear disk 8 is the input shaft of the gearbox 6 and the wheel shaft of the large gear disk 7 is the output shaft of the gearbox 6.

As a preferred embodiment of the invention, the shaft body of the impeller 5 center shaft 4 is provided with a supporting bearing seat 3.

As a preferred embodiment of the invention, generator 11 is equipped with a front bearing seat 10 and a rear bearing seat 12 at each end of the rotor.

As a preferred embodiment of the invention, the bottom of the housing 2 is fixed to the automobile body through the holder 1, and the housing 2 is made of aluminum alloy plate or glass fiber or carbon fiber composite material processing with a thickness of 2 mm.

As a preferred embodiment of the invention, the coupling is provided with a semi-flexible connector structure.

As a preferred embodiment of the invention, the housing 2 is provided with a grille 14 at the air inlet near the end of the impeller 5, and the grille 14 is made of steel wire mesh.

As a preferred embodiment of the invention, the power converter 13 power output end is connected to the vehicle storage battery through the wire.

In the specific implementation of the invention, the automobile wind power generation device is provided at the front of the car and the top position of the car compartment; the gearbox 6 and impeller 5 are provided inside the housing 2, the gearbox 6 input shaft is connected to the impeller 5 central shaft 4 through a coupling, the gearbox 6 output end is connected to the generator 11 rotor shaft through a drive shaft 9, and the generator 11 electrical output end is provided with a power converter 13. When the device is needed to generate electricity, the air is imported at the air inlet of the housing 2, the impeller drives the gearbox 6 through the central shaft 4, the output end of the gearbox 6 drives the rotor of the generator 11 at high speed through the drive shaft 9, and the alternating current from the generator 11 is converted to direct current through the power converter 13 to charge the automobile battery, to guarantee that the power generation is balanced with the energy consumed by the automobile.

The invention and the embodiments thereof are described hereinabove, and this description is not restrictive. What is shown in the drawings is only one of the embodiments of the invention, and the actual structure is not limited thereto. In summary, structural methods and embodiments similar to the technical solution without departing from the inventive purpose of the invention made by inspired ordinary technicians in the art without creative efforts shall all fall within the protection scope of the invention.

1. An electric automobile wind power generation and charging device, wherein the automobile wind power generation device is provided at the front of the car and the top position of the car compartment, and comprises a housing (2), an impeller (5), a gearbox (6) and a generator (11); the gearbox (6) and impeller (5) are provided inside the housing (2), the gearbox (6) input shaft is connected to the impeller (5) central shaft (4) through a coupling, the gearbox (6) output end is connected to the generator (11) rotor shaft through a drive shaft (9), The generator (11) electrical output end is provided with a power converter (13).

2. An electric automobile wind power generation and charging device according to claim 1, wherein the gearbox (6) is provided inside with a large gear disk (7) and a small gear disk (8) connected to each other, the wheel shaft of the small gear disk (8) is the input shaft of the gearbox (6) and the wheel shaft of the large gear disk (7) is the output shaft of the gearbox (6).

3. An electric automobile wind power generation and charging device according to claim 1, wherein the shaft body of the impeller (5) center shaft (4) is provided with a supporting bearing seat (3).

4. An electric automobile wind power generation and charging device according to claim 1, wherein the generator (11) is equipped with a front bearing seat (10) and a rear bearing seat (12) at each end of the rotor.

5. An electric automobile wind power generation and charging device according to claim 1, wherein the bottom of the housing (2) is fixed to the automobile body through the holder (1), and the housing (2) is made of aluminum alloy plate or glass fiber or carbon fiber composite material processing with a thickness of 2 mm.

6. An electric automobile wind power generation and charging device according to claim 1, wherein the coupling is provided with a semi-flexible connector structure.

7. An electric automobile wind power generation and charging device according to claim 1, wherein the housing (2) is provided with a grille (14) at the air inlet near the end of the impeller (5), and the grille (14) is made of steel wire mesh.

8. An electric automobile wind power generation and charging device according to claim 1, wherein the power converter (13) power output end is connected to the vehicle storage battery through the wires.
